(19) United States
(12) Patent Application Publication
(10) Pub. No.: US 2011/0148584 A1
(43) Pub. Date: Jun. 23, 2011

(54) METHOD OF PLACING RFID TAG FOR UNDERGROUND USE UNDER GROUND SURFACE

(75) Inventors: KYONG HEE LEE, Daejeon (KR); Ju Wan KIM, Daejeon (KR); Hae Won SON, Jeollabuk-do (KR); Gwang Ja JIN, Daejeon (KR); Jeong-Ho PARK, Daejeon (KR); Seung Yong LEE, Daejeon (KR); Kyoung-Wook MIN, Daejeon (KR); Jong-Hyun PARK, Daejeon (KR)

(73) Assignees: Electronics and Telecommunications Research Institute, Daejeon (KR); Chonbuk National University Industrial Cooperation Foundation, Jeollabuk-do (KR)

(21) Appl. No.: 12/825,561

(22) Filed: Jun. 29, 2010

(30) Foreign Application Priority Data
Dec. 18, 2009 (KR) 10-2009-0126583

(51) Int. Cl. H04Q 5/22

(52) U.S. Cl. 340/10.1

(57) ABSTRACT

A method includes: placing a Radio Frequency Identification (RFID) tag for underground use under a ground surface, wherein a ground plate which has a diameter greater than that of the RFID tag or a tag antenna and on a top of which the RFID tag is mounted is placed underground such that the RFID tag protrudes above the ground surface or a bottom of the RFID tag is aligned with the ground surface.

### CROSS-REFERENCE(S) TO RELATED APPLICATION(S)

The present invention claims priority of Korean Patent Application No. 10-2009-0126583, filed on Dec. 18, 2009, which is incorporated herein by reference.

### FIELD OF THE INVENTION

The present invention relates to the underground placement of a Radio Frequency Identification (RFID) tag, and, more particularly, to a method of placing an RFID tag for underground use under the ground surface, which is capable of maximizing the coverage distance of the RFID tag when the RFID tag is placed underground.

### BACKGROUND OF THE INVENTION

RFID systems are used in various application fields such as the logistic, traffic, security and safety fields. In general, an RFID system includes one or more RFID tags and one or more RFID readers.

When an object with an RFID tag attached is located in the coverage area of an RFID reader, the RFID reader sends an interrogation signal, obtained by modulating continuous electromagnetic waves having a specific frequency, to the RFID tag. Thereafter, in order to send the information of internal memory to the RFID reader, the RFID tag performs back-scattering modulation on the electromagnetic waves sent by the RFID reader and returns the modulated electromagnetic waves to the RFID reader. Here, back-scattering modulation is a method of, when electromagnetic waves sent by an RFID reader is returned to the RFID reader by an RFID tag through scattering, sending information stored in the RFID tag by varying the size or phase of the scattered electromagnetic waves.

The operation frequency of an RFID tag, the use of a battery and the operation principle of the RFID tag are selected for an object to which the RFID tag will be attached. Although the sizes of RFID tags for attachment to metallic surfaces have been reduced, RFID tags for ground placement under concrete or asphalt support surfaces are problematic in that it is difficult to maintain the RFID tags after underground placement and it is impossible to obtain a sufficient coverage distance when the RFID tags have been placed underground. Furthermore, a guide to ground placement has not been proposed, and the coverage distance between an RFID tag and a reader may be reduced depending on the material of a support surface.

In order to maximize the coverage distance of an RFID tag when it has been placed underground, the maximum output between a reader and the RFID tag is adjusted and a reader or RFID tag having excellent reception sensitivity is selected. However, there is no provision of a method of designing an antenna pattern for an RFID tag and determining an underground placement method, thereby maximizing a coverage distance when the RFID tag has been placed underground.

### SUMMARY OF THE INVENTION

In view of the above, the present invention provides a method of placing an RFID tag for underground use under the ground surface, in which the shape of a ground plate for the RFID tag is adjusted, and the RFID tag is placed underground such that the RFID tag is aligned with the ground surface or protrudes somewhat above the ground surface, thereby maximizing the coverage distance of the RFID tag when the RFID tag is placed underground.

In accordance with an aspect of the present invention, there is provided a method, including:

placing a Radio Frequency Identification (RFID) tag for underground use under a ground surface, wherein a ground plate which has a diameter greater than that of the RFID tag or a tag antenna and on a top of which the RFID tag is mounted is placed underground such that the RFID tag protrudes above the ground surface or a bottom of the RFID tag is aligned with the ground surface.

In accordance with another aspect of the present invention, there is provided a method, including:

placing an RFID tag for underground use under a ground surface, wherein a ground plate which has a diameter greater than that of the RFID tag or a tag antenna, on a top of which the RFID tag is mounted, and a bottom of which is provided with one or more metallic protrusions is placed underground such that part or all of the RFID tag is placed under the ground surface.

### BRIEF DESCRIPTION OF THE DRAWINGS

The objects and features of the present invention will become apparent from the following description of embodiments given in conjunction with the accompanying drawings, in which:

FIG. 1 is a block diagram showing an RFID tag system, which is for explaining an RFID tag for underground use in accordance with an embodiment of the present invention;

FIGS. 2A and 2B are views showing a configuration of an RFID tag which is applied to the embodiment of the present invention;

FIG. 3 is a view showing a ground plate and an RFID tag, which have been attached to each other;

FIGS. 4A and 4B are views showing the shapes of ground plates on which RFID tags for underground use are mounted and the states of the ground plates which have been placed under the ground surface; and

FIGS. 5A and 5B are views showing other structures of ground plates for placing RFID tags for underground use under the ground surface in accordance with the embodiment of the present invention.

### DETAILED DESCRIPTION OF THE PREFERRED EMBODIMENTS

Hereinafter, embodiments of the present invention will be described in detail with reference to the accompanying drawings.

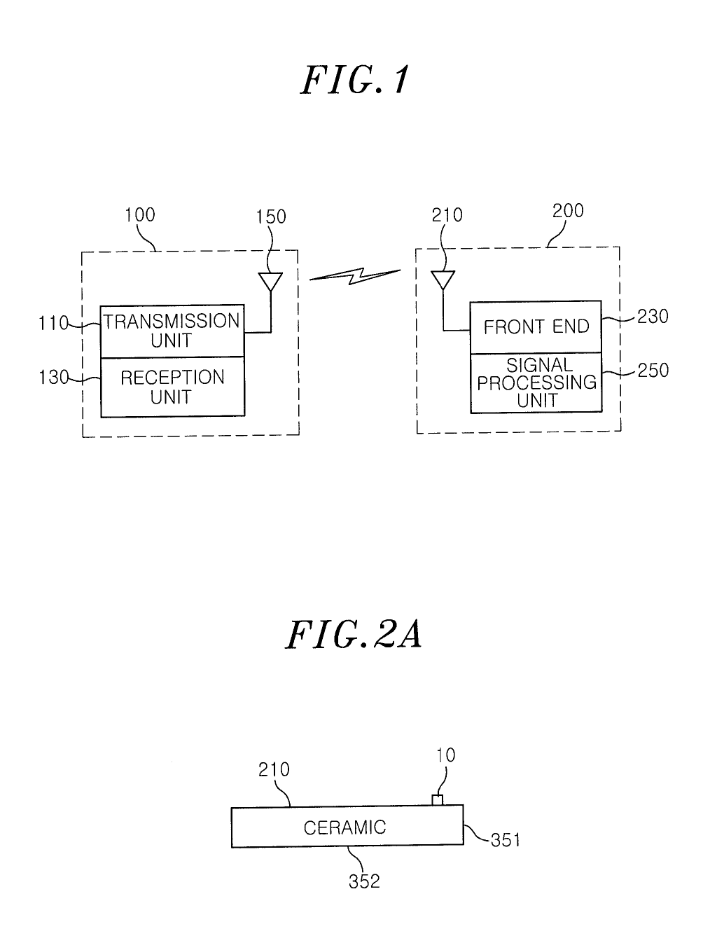

FIG. 1 is a block diagram showing an RFID tag system, which is for explaining an RFID tag for underground use in accordance with an embodiment of the present invention.

As shown in FIG. 1, the RFID tag system includes at least one RFID reader 100 and at least one RFID tag 200. The RFID reader 100 sends an interrogation signal obtained by modulating a continuous electromagnetic wave having a specific frequency and receives a response signal corresponding to the transmitted interrogation signal. The RFID tag 200 receives the interrogation signal sent by the RFID reader 100 and sends a response signal obtained by performing back-scattering modulation on the received signal to the RFID reader 100. Here, the interrogation and response signals correspond to Radio Frequency (RF) signals.

In the embodiment of the present invention, the RFID reader 100 includes a transmission unit 110, a reception unit 130, and a reader antenna 150.

The transmission unit 110 sends an interrogation signal to the RFID tag 200 via the reader antenna 150, and the reception unit 130 receives a response signal from the RFID tag 200 via the reader antenna 150. Here, the reader antenna 150 is electrically connected to the transmission unit 110 and the reception unit 130.

The RFID tag 200 includes a tag antenna 210, a front end 230, and a signal processing unit 250.

The tag antenna 210 receives an interrogation signal sent by the RFID reader 100 and transfers the received interrogation signal to the front end 230. The front end 230 converts the signal transferred by the tag antenna 210 into DC voltage, supplies the DC voltage as power required for the operation of the signal processing unit 250, and extracts a baseband signal from the interrogation signal corresponding to an RF signal.

The signal processing unit 250 receives the baseband signal from the front end 230, performs back-scattering modulation on the input signal, and sends a response signal, corresponding to the interrogation signal sent by the RFID reader 100, to the RFID reader 100.

Here, in order to improve the coverage distance of the RFID system, the tag antenna 210 has to efficiently transmit the received signal to the front end 230 without significant loss. For this purpose, a conjugate match must be provided between the impedance of the tag antenna 210 and the impedance of the front end 230.

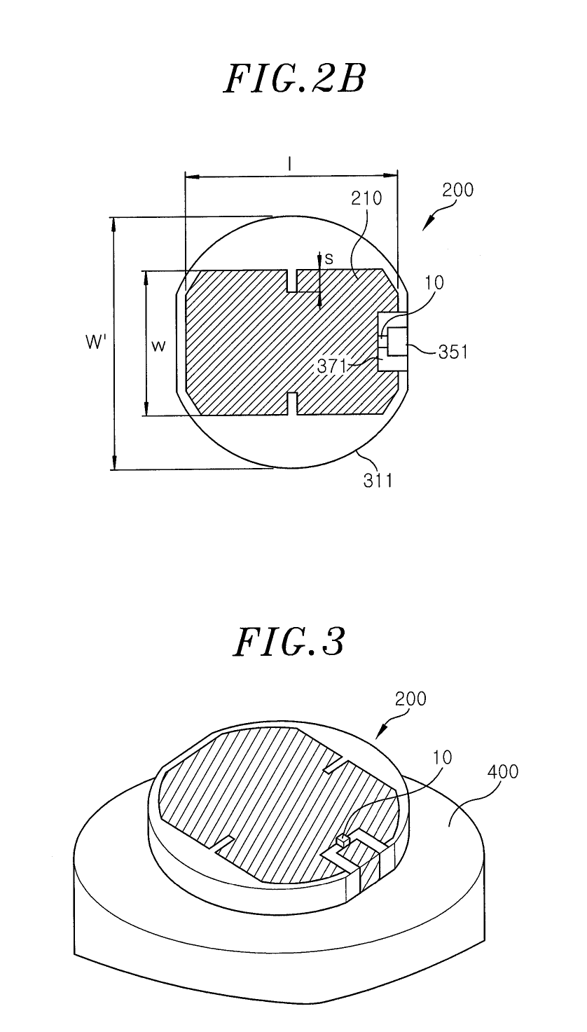

FIGS. 2A and 2B are views showing a configuration of an RFID tag which is applied to the embodiment of the present invention: FIG. 2A is a front view; and FIG. 2B is a top view.

As shown in FIGS. 2A and 2B, the RFID tag 200 includes an RFID tag chip 10, including a front end and a signal processing unit, and a tag antenna 210.

In order to function as an antenna, the tag antenna 210 includes a dielectric substrate 311, a short circuit plate 351, and a feed terminal 371. The tag antenna 210 is a patch antenna having a transmission line structure one end of which is open. One end of a radiation patch is opened, and then a tag chip is installed away from an open location by about 0.5 wavelength. Impedance may be adjusted at the operation frequency of the antenna by fixing the length l of the radiation patch of the tag antenna 210 to 27 mm and adjusting the width w of the patch and the length s of the slot. In the present invention, the dimensions of an RFID tag are designed such that W′=32 mm, w=25 mm and s=3.2 mm.

The dielectric substrate 311 has a polygonal shape including curved edges and rectilinear edges. A bottom surface 352 corresponds to a ground plane. The tag antenna 210 is short-circuited by the short circuit plate 351, and the opposite end is open. The short circuit plate 351 has a rectangular shape, and is disposed on one of the four sides of the dielectric substrate 311, that is, the right side of the dielectric substrate 311 in the drawing.

A method of placing an RFID tag having the above-described configuration underground will be described in detail below with reference to FIGS. 3 to 5.

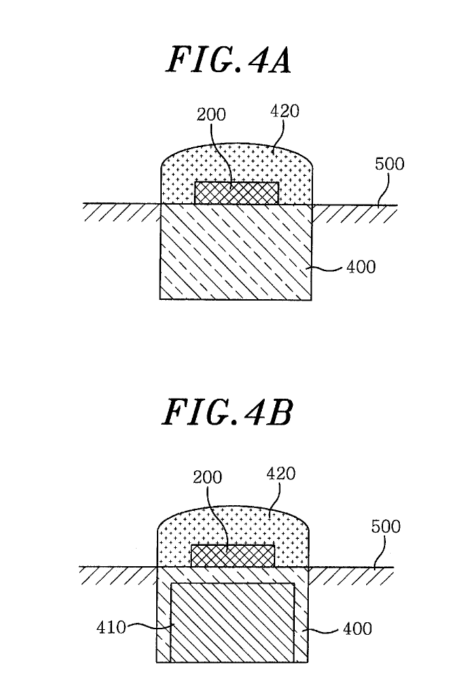

FIG. 3 is a view showing a ground plate and an RFID tag, which have been attached to each other. FIGS. 4A and 4B are views showing the shapes of ground plates on which RFID tags for underground use are mounted and the states of the ground plates which have been placed under the ground surface.

As shown in FIG. 3, an RFID tag 200 is a tag for underground use which is placed under the ground surface. The RFID tag 200 may be mounted on a metal, and may be located on a ground plate 400 which has an area wider than that of the RFID tag 200.

Here, the ground plate 400 has a diameter greater than that of the RFID tag 200 and a specific height, for example, a height equal to or greater than 10 cm. The shape of the ground plate 400 may be a cylinder or a square column shape.

The inside of the ground plate 400 may be empty, as shown in FIG. 4A, or may be filled with an insulating material 410, e.g., plastic, as shown in FIG. 4B. The ground plate 400 may be placed under the ground surface 500. That is, the ground plate 400 may be placed under the ground surface 500 so that the RFID tag 200 protrudes from the ground surface 500 or the bottom surface of the RFID tag 200 is aligned with the ground surface 500.

The RFID tag 200 protruding above the underground ground plate 400 may be protected by a radome 420. The radome 420 is configured to cover not only the RFID tag 200 but also the entire top surface of the ground plate 510.

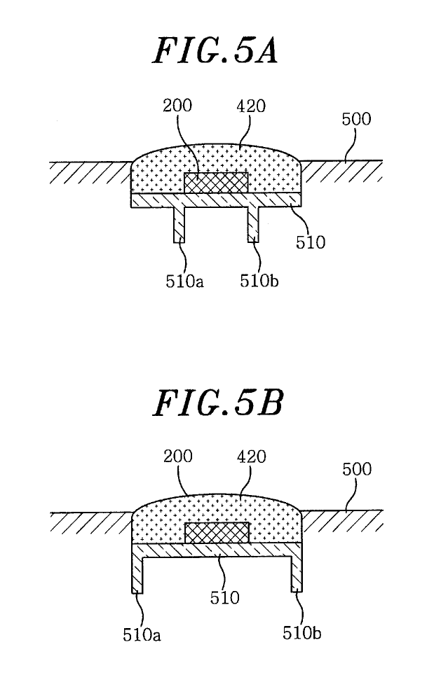

The ground plate 400 used in the embodiment may be implemented using metallic material, or may be implemented by plating an insulating material, e.g., a plastic with a metal or by attaching a metallic tape to the insulating material. FIGS. 5A and 5B are views showing other structures of ground plates for placing an RFID tag for underground use under the ground surface in accordance with the embodiment of the present invention.

As shown in FIG. 5A, an RFID tag 200 is mounted on the top of a ground plate 510 and metallic protrusions 510a and 510b are formed on the bottom of the ground plate 510.

Furthermore, the ground plate 510 has a diameter greater than that of the RFID tag 200, for example, two or more times greater than that of the RFID tag 200, and has a thickness less than that of the RFID tag 200.

The ground plate 510 may be placed under a ground surface 500. As shown in FIG. 5A, the RFID tag 200 may be placed underground such that the entire RFID tag 200 is placed under the ground surface 500, and the RFID tag 200 may be protected by the radome 420. The radome 420 is configured to cover not only the RFID tag 200 but also the entire top of the ground plate 510.

The ground plate 510 may be formed by plating an insulating material, e.g., a plastic with a metal or by attaching a metallic tape to the insulating material.

As described above, the metallic protrusions 510a and 510b are formed on the bottom of the ground plate 510, so that the gain of the tag antenna 210 of the RFID tag 200 can be increased.

As shown in FIG. 5B, metallic protrusions 510a and 510b are formed by bending a ground plate 510 at the right and left ends thereof and an RFID tag 200 is mounted on the top of the ground plate 510.

The ground plate 510 configured as described above may be placed under the ground surface 500. That is, as shown in FIG. 5B, the RFID tag 200 may be placed underground such that the entire RFID tag 200 is placed under the ground surface 500 and the RFID tag 200 may be protected by a radome 420. The radome 420 is configured to cover not only the RFID tag 200 but also the entire top of the ground plate 510.

Although in the embodiment of the present invention, the ground plate 510 has been described as being placed underground such that the entire RFID tag 200 is placed under the ground surface 500 as an example, the ground plate 500 may be placed underground such that part of the RFID tag 200 protrudes.

The ground plate 510 used in the present embodiment of the present invention may be implemented using metallic material, or may be implemented by plating an insulating material, e.g., a plastic with a metal or by attaching a metallic tape to the insulating material.

According to the embodiment of the present invention, the gain of the tag antenna 210 of the RFID tag 200 can be increased by placing the RFID tag 200 using the ground plate 510 configured such that the right and left ends thereof are bent.

According to the present invention, if the outside of the ground plate is covered with metal although the ground plate is not made of metal or filled with metal therein, the gain of the tag antenna is not influenced, so that the coverage distance of the RFID tag can be maximized by attaching the RF tag to the ground plate and placing them underground.

Furthermore, according to the present invention, the shape of the ground plate for the RFID tag is adjusted within a limited size and the RFID tag is placed underground such that the RFID tag is aligned with the ground surface or protrudes somewhat above the ground surface, thereby maximizing the coverage distance.

According to the present invention, when the RFID tag is placed deep under the ground surface, the coverage distance can be maximized by attaching one or more metallic protrusions, that is, one or more small-sized columns, to the bottom of the ground plate under the RFID tag.

Due to these advantages, the RFID tag in accordance with the present invention can be used as a surveying point, in which case there is an advantage in that the RFID tag has a coverage distance greater than that of a typical RFID tag for underground use. Furthermore, when a moving object equipped with an RFID reader passes through the location where the RFID tag was placed underground, the RFID tag is detected by the RFID reader, thereby providing the advantage of tracking the location of the moving object.

Furthermore, according to the present invention, the RFID tag for underground use may be placed under the ground surface, may be applied to a building or column made of any of a variety of types of material such as concrete, or the shape of the ground plate may be adjusted and then the RFID tag may be placed under a surface made of any of a variety of types of material, thereby increasing the coverage distance.

While the invention has been shown and described with respect to the embodiments, it will be understood by those skilled in the art that various changes and modification may be made without departing from the scope of the invention as defined in the following claims.

What is claimed is:

1. A method, comprising:
placing a Radio Frequency Identification (RFID) tag for underground use under a ground surface, wherein a ground plate which has a diameter greater than that of the RFID tag or a tag antenna and on a top of which the RFID tag is mounted is placed underground such that the RFID tag protrudes above the ground surface or a bottom of the RFID tag is aligned with the ground surface.

2. The method of claim 1, wherein the ground plate has a circular or square column shape.

3. The method of claim 1, wherein the ground plate is made of metal.

4. The method of claim 3, wherein an inside of the ground plate is empty or is filled with an insulating material.

5. The method of claim 4, wherein the insulating material is plastic.

6. The method of claim 1, wherein the ground plate is formed by plating an insulating material with a metallic material or by attaching a metallic tape to the insulating material.

7. A method, comprising:
placing an RFID tag for underground use under a ground surface, wherein a ground plate which has a diameter greater than that of the RFID tag or a tag antenna, on a top of which the RFID tag is mounted, and a bottom of which is provided with one or more metallic protrusions is placed underground such that part or all of the RFID tag is placed under the ground surface.

8. The method of claim 7, wherein the ground plate is made of metal.

9. The method of claim 7, wherein the ground plate is formed by plating an insulating material with a metallic material or by attaching a metallic tape to the insulating material.

10. The method of claim 7, wherein the metallic protrusions are formed by bending the ground plate at right and left ends thereof.
